(19) United States
(12) Patent Application Publication
(10) Pub. No.: US 2014/0278564 A1
(43) Pub. Date: Sep. 18, 2014

(54) DYNAMIC PRICING OF GUARANTEE PRODUCTS

(71) Applicant: TRANSAMERICA CORPORATION, San Francisco, CA (US)

(72) Inventors: Darin Smith, Marion, IA (US); David Hopewell, Iowa City, IA (US)

(73) Assignee: TRANSAMERICA CORPORATION, San Francisco, CA (US)

(21) Appl. No.: 13/836,964

(22) Filed: Mar. 15, 2013

(51) Int. Cl. G06Q 40/08

(52) U.S. Cl. CPC G06Q 40/08
USPC 705/4

(57) ABSTRACT

Methods and apparatuses, including computer program products, are described for dynamic pricing of guarantee products. A server computing device determines a fee factor for a guarantee product based on an allocation of assets in an investment account linked to the guarantee product. The server computing device assigns an investment profile to the guarantee product based on the fee factor. The server computing device determines a fee percentage for the guarantee product based on the investment profile and a fee payment option selected by an owner of the guarantee product. The server computing device generates a notification including a fee amount for the guarantee product based on the fee percentage.

### FIELD OF THE INVENTION

This application relates generally to methods and apparatuses, including computer program products, for dynamic pricing of guarantee products.

### BACKGROUND

Insurance companies have traditionally offered insurance products which allow customers to receive a schedule of payments at a later date in exchange for a purchase of the product. Often, the future schedule of payments is guaranteed by the insurance company, provided that specific criteria and requirements of the product are met. These products can take many forms, such as annuity products, standalone living benefit products, and other similar products. The guarantees can take many forms, including guaranteed minimum death benefits, income benefits, withdrawal benefits, lifetime withdrawal benefits, account value guarantees (e.g., GMAB), and other similar guarantees.

An insurance company may offer a product that provides a guaranteed benefit to investors, where the product is linked to an investment account (e.g., 401(k) account, IRA account, or mutual fund account) held by the investor. These investment accounts can have an allocation of assets across different investment types, from conservative investments such as cash and government securities to more risky investments such as international stocks and small company equities. The product may be in the form of a certificate that provides guaranteed benefit payments for a particular time period, such as over the life of the investor (and, in some cases, his or her spouse), if a specified event occurs, such as if the assets in the linked investment account are depleted, and subject to certain conditions.

In order to manage the risk associated with providing such guaranteed benefits, the insurance company imposes significant restrictions on the allocation of assets that are permissible in the linked investment account. Frequently, the investor must maintain a prescribed allocation of assets in his or her investment account. If the allocation of assets falls outside of the prescribed requirements due to, e.g., fluctuations in the economic marketplace, the insurance company may notify the investor and force the investor to rebalance the asset allocation in the investment account to meet the product requirements, or in some cases the insurance company may assess penalties against the investment account, including the potential cancellation of the underlying policy. In some cases, due to degrees of risk associated with a range of asset allocation offerings, the insurance company has no flexibility to offer its customers different types of asset allocation. Instead, the insurance company forces a single asset allocation on its customers to manage risk in a reasonable way.

In the above scenario, the insurance company will likely own or manage the investment account that is linked to the product, or have a certain element of control over the asset allocation in the investment account. Recently, investors have desired to purchase products with guaranteed benefit payments for accounts that are not within the control of the insurance company that offers the product. In these cases, the insurance company is not always able to force the investor to rebalance the asset allocation, leading to an increase in the risk assumed by the insurance company. Furthermore, when the investment account is not in compliance with the product requirements, the insurance company has to initiate the notice and penalty phases described above—resulting in additional maintenance and administration costs to both the insurance company and the investor.

Also, the insurance company usually charges fees associated with the continued maintenance of the product to the investor by deducting the fee amount from the investment account. In doing so, the cost to the insurance company for providing the guarantee goes up because the value of the investment account is reduced; thereby increasing the chance that the insured event occurs, such as the investment account becomes depleted, and the insurance company must begin the guarantee payments.

### SUMMARY OF THE INVENTION

What is needed is a way for insurance companies to price insurance products dynamically based on the asset allocation in the investment account linked to the insurance product, to account for the risk associated with the asset allocation. In general overview, the techniques described herein are related to dynamic pricing of insurance products. The techniques provide the advantage of compensating an insurance company adequately for the amount of risk associated with a specific asset allocation selected by a customer. The techniques also provide the advantage of providing investors with a flexible mechanism to allocate the assets in their insurance products according to their own investment preferences while receiving a price on the insurance product that is reflective of the risk involved.

The invention, in one aspect, features a computerized method for dynamic pricing of guarantee products. A server computing device determines a fee factor for a guarantee product based on an allocation of assets in an investment account linked to the guarantee product, the fee factor representing a level of risk associated with the allocation of assets. The server computing device assigns an investment profile to the guarantee product based on the fee factor. The server computing device determines a fee percentage for the guarantee product based on the investment profile and a fee payment option selected by an owner of the guarantee product. The server computing device generates a notification including a fee amount for the guarantee product based on the fee percentage.

The invention, in another aspect, features a system for dynamic pricing of guarantee products. The system includes a server computing device with a processor configured to determine a fee factor for a guarantee product based on an allocation of assets in an investment account linked to the guarantee product, the fee factor representing a level of risk associated with the allocation of assets. The processor is configured to assign an investment profile to the guarantee product based on the fee factor and determine a fee percentage for the guarantee product based on the investment profile and a fee payment option selected by an owner of the guarantee product. The processor is configured to generate a notification including a fee amount for the guarantee product based on the fee percentage.

The invention, in another aspect, features a computer program product, tangibly embodied in a non-transitory computer readable storage medium, for dynamic pricing of guarantee products. The computer program product includes instructions operable to cause a data processing apparatus to determine a fee factor for a guarantee product based on an allocation of assets in an investment account linked to the guarantee product, the fee factor representing a level of risk associated with the allocation of assets. The computer program product includes instructions operable to cause the data processing apparatus to assign an investment profile to the guarantee product based on the fee factor, and determine a fee percentage for the guarantee product based on the investment profile and a fee payment option selected by an owner of the guarantee product. The computer program product includes instructions operable to cause the data processing apparatus to generate a notification including a fee amount for the guarantee product based on the fee percentage.

In some embodiments, any of the above aspects can include one or more of the following features. In some embodiments, the step of determining a fee factor includes determining a covered asset value for each investment choice in the investment account in which assets are allocated, the covered asset value being a value of assets in the fund multiplied by a fund factor, and determining the fee factor by dividing the total covered asset value for every investment choice in the investment account by the total value of assets in the investment account. In some embodiments, the fund factor is based a level of volatility of the associated fund. In some embodiments, the fund factor is based on a level of equity exposure of the associated fund. In some embodiments, the fund factor is based on a confidence rating of the associated fund.

In some embodiments, the fee payment option provides that the fee amount is deducted from a separate cash account associated with the guarantee product. In some embodiments, the fee payment option provides that the fee amount is deducted from the investment account associated with the guarantee product.

In some embodiments, the server computing device periodically adjusts the fee factor based on changes to the allocation of assets in the investment account, and updates the investment profile based on the adjusted fee factor. In some embodiments, the server computing device periodically determines whether the allocation of assets in the investment account satisfies a compliance threshold, and generates a notification for the owner of the guarantee product whenever the allocation of assets does not satisfy the compliance threshold. In some embodiments, the server computing device rebalances the allocation of assets in the investment account whenever the allocation of assets does not satisfy the compliance threshold. In some embodiments, the server computing device determines a new fee percentage and fee amount whenever the fee payment option is changed.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a timeline for a guarantee product offered by an insurance company to be linked to an investment account held by an investor.

FIG. 2 is a block diagram of a system for dynamic pricing of guarantee products.

FIG. 3 is a flow diagram of a method for dynamic pricing of guarantee products.

FIG. 4 is a flow diagram of a method for performing an action or series of actions whenever the Covered Asset Pool is no longer in compliance with composition requirements.

FIG. 5 is a block diagram of a networked system for dynamic pricing of guarantee products.

### DETAILED DESCRIPTION

The techniques described herein provide the advantage of enabling insurance companies to provide dynamic pricing for guaranteed investment products such as annuities, according to the level of risk assigned to a covered asset pool associated with the product. The techniques provide the advantage of giving the owner additional freedom and flexibility to invest as he or she deems appropriate without being limited to specific groups or tiers of funds. The techniques also protect the guarantor by charging for the risk appropriately based on the asset mix selected by the owner.

FIG. 1 is a block diagram of a timeline 100 for a guarantee product offered by an insurance company (also called a guarantor) to be linked to an investment account held by an investor. The timeline 100 begins when the investor purchases the product from the guarantor, and ends when the insured event occurs. The guarantee product offered by the guarantor can include an immediate or deferred fixed or variable annuity, a contingent deferred annuity, or a standalone living benefit. The guarantee associated with the guarantee product can include a guaranteed minimum death benefit, an income benefit, a withdrawal benefit, a lifetime withdrawal benefit, or an account value guarantee. The product can take the form of a certificate issued by the guarantor on the assets in the investment account, although other forms of the product are included within the spirit and scope of the invention. For example, the investor may purchase the certificate for protection in the event of potential future withdrawals from the account, sub-par or poor market performance, or both. The certificate provides guaranteed benefit payments over a certain time period if and when an insured event occurs. For example, the time period can be the life of the investor (and, if applicable, his spouse under a joint certificate). The insured event occurs at a date after the guarantee product is purchased, and the insured event triggers the stream of benefit payments under the guarantee product. In some embodiments, the insured event is the depletion of the assets in the investment account (also called the “Covered Asset Pool” or “Covered Asset Pool account”) during a defined time period (e.g., the lifetime of the investor (or spouse)), when the depletion occurs other than by an excess withdrawal from the investment account. In some embodiments, an excess withdrawal occurs when the investor withdraws more than the amount covered by the certificate (also called the “Coverage Amount”) during a time period as defined by the certificate. In some embodiments, the defined time period is one year (also called the “Certificate Year”).

In some embodiments, the assets held in the Covered Asset Pool are to comply with requirements set forth by the guarantor issuing the certificate. For example, the assets must be of a certain type and/or the total value of the assets must meet a required minimum value (e.g., $100,000) or a required maximum value (e.g., $1 M). In some embodiments, the investor, and optionally his spouse, must be of a particular age when purchasing the certificate (e.g., between 45 and 90). In some embodiments, the age difference between the investor and his spouse must not exceed a maximum value (e.g., 10 years) in order to purchase a joint certificate.

Generally, the certificate provides a guarantee that, under certain specified conditions, and regardless of the investment performance of the Covered Asset Pool and regardless of how long the investor lives, he is able to receive a guaranteed level of income for a certain period of time (e.g., for life, and the life of his spouse under a joint certificate). This income comes first in the form of withdrawals taken from the Covered Asset Pool, and when an insured event occurs (e.g., when the Covered Asset Pool reaches a zero-dollar value), from guaranteed benefit payments that the insurance company pays to the investor.

Continuing with FIG. 1, at time t1, the investor, who owns assets (e.g., cash, stocks, bonds, or other equity instruments) being held in an investment account (e.g., mutual fund, money market account, 401(k), IRA, or other investment vehicle)—the Covered Asset Pool account—purchases a guarantee product (e.g., a certificate) from the guarantor to cover the assets in the investment account. The event at time t1 is also known as the “Certificate Date” (102). For example, the investor may want protection based on potential future withdrawals from the account, sub-par or poor market performance, or both. Once the certificate is purchased, the investor is also known as the “Certificate Owner.”

In some embodiments, a cash account is established within the Covered Asset Pool and the guarantee applies only to the assets in the non-cash account portion of the Covered Asset Pool. For example, assume the investor contributes $100,000 in cash to his investment account at time t1. The investor elects to allocate $90,000 to assets in the investment account and the remaining $10,000 is held in the cash account. In this example, the guarantee only covers the $90,000 associated with the non-cash account portion of the Pool. The $10,000 can be used, e.g., to pay fees levied by the insurance company for providing the guarantee product. In some embodiments, a second investment account is established within the Covered Asset Pool and the guarantee does not apply to the second investment account portion of the Covered Asset Pool. For example, assume the investor contributes $100,000 in cash to his investment account at time t1. The investor elects to allocate $90,000 to assets in the main investment account and the remaining $10,000 is held in assets in the second investment account. In this example, the guarantee only covers the $90,000 in the main investment account portion of the Pool.

At time t2, the investor selects a “Lock-In Date” (104) at which point he is permitted to make withdrawals from the Covered Asset Pool without adjustments to a Coverage Base associated with the guarantee product. And, at time t3, the “Insured Event Date” (106), an “Insured Event” occurs, meaning that the guarantor begins to make benefit payments under the certificate. In some embodiments, the Insured Event occurs when the Covered Asset Pool account has been depleted (i.e., reduced to a zero-dollar value) by transactions other than excess withdrawals. More detail about the timeline 100 is set forth below.

At time t1, the guarantor determines an initial Coverage Base for the certificate. The Coverage Base is an amount used to calculate the initial Coverage Amount for the certificate. On the Certificate Date, the Coverage Base is set equal to the value of the Certificate Owner's Covered Asset Pool. As an example, at time t1, when the Certificate Owner purchases the certificate, he has $100,000 invested in the Covered Asset Pool in the investment account. Therefore, the initial Coverage Base for the certificate on the Certificate Date is $100,000. However, the Coverage Base is not the same as the Covered Asset Pool. The Coverage Base is typically used only in calculating the initial Coverage Amount.

The Coverage Base can increase in certain circumstances. For example, after the Certificate Date at time t1 and before the Lock-In Date at time t2, the Coverage Base is increased by any subsequent contributions to the Certificate Owner's Covered Asset Pool and is decreased for any withdrawals. In some embodiments, subsequent contributions are permitted until the Lock-In Date and, after the Lock-In Date at time t2, subsequent contributions are no longer permitted. In some embodiments, the Certificate Owner can make additional contributions after the Lock-In Date, with a corresponding adjustment to the Coverage Amount. In some embodiments, the sum of the initial contribution and any subsequent contributions may not exceed the maximum total contributions specified by the certificate. In some embodiments, subsequent contributions do not include dividends or other distributions reinvested in the Covered Asset Pool.

For example, assume that the Coverage Base and Covered Asset Pool are both $100,000, and that the Certificate Owner then makes a contribution of $25,000. Upon making the Contribution, the Coverage Base and the Covered Asset Pool increases to $125,000. Assume that on the next Certificate Anniversary, the value of the Covered Asset Pool has decreased to $120,000, e.g., due to market declines. The Coverage Base remains $125,000. Assume that during the following Certificate Year, the Covered Asset Pool is still at $120,000 and the Certificate Owner makes a contribution of $5,000. The Coverage Base increases to $130,000, even though the Covered Asset Pool increases only to $125,000. Assume that on the following Certificate Anniversary, the Covered Asset Pool has increased to $135,000, due to market gains and that this value represents the highest value of the four prior three-month periods. The Coverage Base increases to $135,000.

In some embodiments, the Coverage Base decreases whenever the Certificate Owner makes an excess withdrawal before the Lock-In Date. Prior to the Lock-In Date, an excess withdrawal is the full amount of any withdrawal (because the Coverage Amount is zero before the Lock-In Date). An excess withdrawal prior to the Lock-In Date reduces the Coverage Base by the greater of (1) the excess withdrawal amount, or (2) a pro rata amount in proportion to the reduction in the value of the Covered Asset Pool. More specifically, prior to the Lock-In Date an excess withdrawal reduces the Coverage Base by the greater of (1) or (2):

(1) is the excess withdrawal amount; and

(2) is the result of c multiplied by d and divided by e (i.e., (c×d)/e)

where:

c=the excess withdrawal amount;

d=the value of the Covered Asset Pool before the excess withdrawal; and

e=the Coverage Base prior to the withdrawal.

For example, assume, before the Lock-In Date, that the Coverage Base is $100,000, and that the value of the Covered Asset Pool is $90,000 on the withdrawal date. Assume that the Certificate Owner withdraws $1,000 in a Certificate Year. Because the Coverage Amount is zero prior to the Lock-In Date, the Certificate Owner has made an excess withdrawal of $1,000. The excess withdrawal ($1,000) multiplied by the Coverage Base before the excess withdrawal ($100,000), and then divided by the value of the Covered Asset Pool ($90,000):

($1,000×$100,000)/($90,000)=$1111.11

$1111.11 is greater than the excess withdrawal of $1,000. Therefore, the Coverage Base is reduced by $1111.11. The new Coverage Base is $98,888.89.

Also, at time t1, the “Coverage Amount” of the certificate is $0. The “Coverage Amount” is the amount of withdrawals permitted each period (e.g., each Certificate Year) after the Lock-In Date, and the Coverage Amount also equals the amount of the benefit payments guaranteed to be paid to the Certificate Owner each year after the Insured Event occurs (e.g., in the event that the Covered Asset Pool is depleted in accordance with the conditions specified in the certificate). The Coverage Amount is initially calculated when the coverage provided under the certificate begins, by multiplying the “Coverage Percentage” by the “Coverage Base” (as described below). Any withdrawal taken from the Covered Asset Pool during the initial period (e.g., from time t1 to time t2) is considered an excess withdrawal. Such withdrawals have the potential to significantly decrease and even terminate the benefits provided by the certificate.

On each Certificate Anniversary before the Lock-In Date, the Certificate Owner's Coverage Base will be the greatest of: 1) the current Coverage Base; 2) the value of the Certificate Owner's Covered Asset Pool on the Certificate Anniversary; or 3) if there have been no withdrawals during the preceding Certificate Year, the value of the Certificate Owner's Covered Asset Pool as of any specified time period (e.g., a three-month period) during the immediately preceding Certificate Year. If the Certificate Owner's Coverage Base increases pursuant to 2 or 3, the increase is treated as an automatic step-up. The fee percentage assigned to the certificate (the “Certificate Fee Percentage”) may increase due to an automatic step-up of the Coverage Base (unless the step-up is rejected by the Certificate Owner). In some embodiments, the Certificate Fee Percentage never exceeds a predetermined maximum amount.

At time t2, the Certificate Owner selects (104) a “Lock-In Date” at which point he can make withdrawals from the Covered Asset Pool up to the Coverage Amount without the withdrawals being considered as excess withdrawals. In some cases, the Certificate Owner can make withdrawals above the Coverage Amount during a particular period specified in the certificate (e.g., one Certificate year or one calendar year), but the Certificate Owner may be penalized for doing so, in the form of an excess withdrawal fee, a reduction in his Coverage Amount, or both. In some embodiments, contributions to the Covered Asset Pool account are no longer allowed after the Lock-In Date. In some embodiments, the Lock-In Date is no earlier than the date the Certificate Owner (or where joint coverage is selected, the date the younger spouse) attains a specific age (e.g., age 60). In some embodiments, the Coverage Percentage is determined by (i) the Certificate Owner's attained age (i.e., age at last birthday) (or for a joint certificate, the age of the younger spouse) at the Lock-In Date, and (ii) a specified benchmark value, such as the current 10-year United States Treasury Bond Yield. In some embodiments, the Coverage Percentage has a cap and/or a floor. For example, the Coverage Percentage can range from a floor of 4% to a cap of 8%. Before the Insured Event occurs (e.g., the Covered Asset Pool is depleted), the Coverage Amount is also the maximum amount that the Certificate Owner may withdraw in one Certificate Year without causing an excess withdrawal.

For example, the Certificate Owner purchases a certificate at age 65 and the Coverage Base on the Lock-In Date is $100,000. This means that the initial Coverage Amount equals $100,000 multiplied by the applicable Coverage Percentage. Assume that the applicable Coverage Percentage is 5.0%. Then, the initial Coverage Amount equals $5,000. Therefore, before the Insured Event, the Certificate Owner may withdraw $5,000 annually (i.e., each Certificate Year) from the Covered Asset Pool without reducing the benefits guaranteed to him under the certificate. If the Insured Event occurs (and all other conditions are satisfied, if any), then the guarantor pays the Certificate Owner $5,000 annually (in monthly or other periodic payments) for a certain time period. In some embodiments, the payments are made until the Certificate Owner's death. In some embodiments, the payments are made for a specific number of time intervals (e.g., months or years).

After the Lock-In Date at t2 104, but before the Insured Event Date at t3 106, the Coverage Amount is calculated on each Certificate Anniversary (i.e., the anniversary of the date on which the certificate was purchased). On each Certificate Anniversary after the Lock-In Date, the Certificate Owner's Coverage Amount will be the greater of: 1) the current Coverage Amount; or 2) the current value of the Covered Asset Pool on the Certificate Anniversary multiplied by the current Coverage Percentage as determined by the Certificate Owner's attained age (e.g., age at last birthday) (or for a joint certificate, the age of the younger spouse) at the Lock-In Date and a benchmark value (e.g., the current 10-year United States Treasury Bond Yield). If the Certificate Owner's Coverage Amount increases pursuant to 2, the increase is treated as an automatic step-up. The Certificate Fee Percentages may increase (or decrease) due to an automatic step-up of the Coverage Amount (unless the step-up is rejected by the Certificate Owner).

For example, assume the initial Coverage Amount equals $5,000. On a Certificate Anniversary the value of the Covered Asset Pool is $95,000. Assume that the Coverage Percentage, based on a benchmark such as the 10-year United States Treasury Bond Yield and the Certificate Owner's age at the Lock-In Date, is 5.5%. Therefore, on that Certificate Anniversary, the Coverage Amount is recalculated as $5,225. (5.5% of $95,000 equals $5,225.) Accordingly, before the Insured Event, the Certificate Owner may withdraw $5,225 annually (i.e., each Certificate Year) from the Covered Asset Pool without reducing the guaranteed benefits. If the Insured Event occurs (and all other conditions are satisfied, if any), then the guarantor pays the Certificate Owner $5,225 annually (in monthly or other periodic payments) for a specific time period, such as until the Certificate Owner's death.

In some embodiments, any withdrawals made above the Coverage Amount in any Certificate Year result in a decrease of the benefits provided by the certificate, and in some cases, result in termination of the benefits provided by the certificate. Also, in some embodiments, if the Certificate Owner does not withdraw the entire Coverage Amount in any Certificate Year, the “unused” amount is not carried over to the next year.

In some embodiments, the Coverage Amount decreases whenever the Certificate Owner makes an excess withdrawal. After the Lock-In Date, an excess withdrawal occurs if the Certificate Owner withdraws more than the Coverage Amount in any Certificate Year (or an optional additional Coverage Amount in any calendar year). As described above, in some embodiments, Coverage Amounts are based on Certificate Years, and not on calendar years. The excess withdrawal is the amount withdrawn in excess of the Coverage Amount. In addition, dividends, capital gains, and other distributions from Covered Assets that are not reinvested can be treated as withdrawals.

In some embodiments, an excess withdrawal after the Lock-In Date reduces the Coverage Amount on a pro rata basis in proportion to the reduction in the value of the Covered Asset Pool. Therefore, after the Lock-In Date, an excess withdrawal can reduce the Coverage Amount by a dollar amount that is greater than the amount of the excess withdrawal. Excess withdrawals may reduce and even eliminate the benefits of the certificate. More specifically, after the Lock-In Date an excess withdrawal reduces the Coverage Amount according to the following formula: f multiplied by g and divided by h (i.e., (f×g)/h) where:
f=the excess withdrawal amount (i.e., the amount withdrawn in excess of the Coverage Amount that remained before the withdrawal);
g=the value of the Covered Asset Pool after the Coverage Amount has been withdrawn, but before the excess withdrawal; and
h=the Coverage Amount prior to the withdrawal.

For example, assume that the Coverage Base is $100,000 and the Coverage Amount is $5,000. Assume that the Certificate Owner initially withdraws $3,000 in a Certificate Year. This amount is below the Coverage Amount of $5,000, so there is no excess withdrawal. Assume that in the same Certificate Year, the Certificate Owner later withdraws an additional $3,000 and that prior to this withdrawal, the value of the Covered Asset Pool was $97,000. When added to the previous Withdrawal of $3,000, the Certificate Owner has made an excess withdrawal of $1,000.

The excess withdrawal ($1,000) multiplied by the Coverage Amount prior to the withdrawal ($5,000) divided by the value of the Covered Asset Pool ($97,000) after the remaining Coverage Amount ($2,000) is withdrawn:

($1,000×$5,000)/($97,000−$2,000)=$52.63

Therefore, the Coverage Amount is reduced by $52.63. The new Coverage Amount is $4,947.37.

At time t3, the Insured Event occurs (106), which triggers the initiation of benefit payments by the guarantor. In some embodiments, the Insured Event occurs when the Covered Asset Pool has been depleted (i.e., reduced to a zero-dollar value) by transactions other than excess withdrawals. Generally, no benefits are paid until the Insured Event occurs.

In some embodiments, additional conditions must be met before the benefit payments begin. For example, if the Insured Event occurs and all of the following are true, then the Certificate Owner is entitled to benefit payments under the Certificate:

(1) The certificate is in force;

(2) The Lock-In Date has been established;

(3) The Certificate Owner (or his or her spouse under a joint certificate) is alive;

(4) The Coverage Amount is greater than zero;

(5) All fees due under the certificate are paid;

(6) Any other conditions of the certificate (and/or contract between the guarantor and Certificate Owner, if applicable) are met.

If the above are true, then the guarantor pays the Certificate Owner the Coverage Amount each Certificate Year (after the Certificate Year in which the Insured Event occurs, for which the guarantor pays any remaining Coverage Amount). For example, assume the Certificate Owner had a Coverage Amount of $5,000 and he had taken $3,200 in standard withdrawals during the current Certificate Year. Then, the Insured Event occurred; in this example, the remaining value of the Covered Asset Pool was reduced to zero due to a market downturn. The guarantor would make an initial benefit payment of $1,800—the Coverage Amount minus the previous withdrawal. In the next Certificate Year, the guarantor makes a payment equal to the full Coverage Amount of $5,000.

In some embodiments, the benefit payments are divided into monthly (or other periodic) payments, as elected by the Certificate Owner and agreed to by the guarantor. The payments are paid to the Certificate Owner for a specific time period, such as until his or her death (or the death of his or her spouse, if later, under a joint certificate).

As mentioned above, the certificate is subject to fees charged by the guarantor for providing the benefits under the certificate. The “Certificate Fee” (i.e., the fee paid by the Certificate Owner for the benefits provided under the certificate) is calculated and due on the Certificate Date and thereafter at specific time periods (e.g., each three-month period). In some embodiments, the guarantor transmits a notice to the Certificate Owner if the fee is not paid as of the due date. If the fee is not paid within a predetermined time period from the due date, the guarantor may elect to terminate the certificate and the corresponding payment of benefits is eliminated. As will be explained in greater detail below, the guarantor can impose limitations or restrictions on the allocation of assets in the Covered Asset Pool in order to manage the risk associated with providing the guarantee.

In some embodiments, the Certificate Fee is calculated and due on the Certificate Date and thereafter at specified periods (e.g., each three-month date) after the Certificate Date. In some embodiments, the Certificate Fee is calculated using an applicable annualized fee percentage (“Certificate Fee Percentage”) multiplied by the value of the Certificate Owner's Covered Asset Pool on the calculation date times the number of days in a Certificate Year quarter divided by the number of days in the Certificate Year. More specifically, the Certificate Fee is calculated by multiplying j by k by l, where:

j=the value of the Covered Asset Pool as of the calculation date;

k=the applicable Certificate Fee Percentage; and

l=the number of days in the current Certificate Year quarter divided by the number of days in the Certificate Year.

In some embodiments, the Certificate Fee is no longer applicable upon the occurrence of the Insured Event, such as when the Covered Asset Pool is depleted to a zero-dollar value, or termination of the guarantee product.

FIG. 2 is a block diagram of a system 200 for dynamic pricing of insurance products based on the allocation of assets in the Covered Asset Pool. The system 200 includes a server computing device 202 for implementing the computer processing in accordance with a computer-implemented embodiment of the present invention. The methods described herein may be presented in terms of program procedures executed on, for example, a computer or network of computers. The server computing device 202 includes a dynamic pricing module 204 and a fee charging module 206. The dynamic pricing module 204 and fee charging module 206 are hardware and/or software modules located in the server computing device 202 and used to execute the methods for dynamic pricing of insurance products based on the allocation of assets in the Covered Asset Pool as described herein. In some embodiments, the server computing device 202 is located on a communication network (e.g., Internet, WAN, or LAN) and communicating with other computing devices (not shown). In some embodiments, the functionality of the dynamic pricing module 204 and fee charging module 206 is distributed among a plurality of computing devices. It should be appreciated that any number of computing devices, arranged in a variety of architectures, resources, and configurations (e.g., cluster computing, virtual computing, cloud computing), can be used without departing from the scope of the invention.

FIG. 3 is a flow diagram of a method 300 for dynamic pricing of guarantee products based on allocation of assets in the Covered Asset Pool, using the system 200 of FIG. 2. The server computing device 202 receives data (e.g., Owner data, asset allocation data) pertaining to the guarantee product and corresponding investment account. The server computing device 202 determines (302) a fee factor for a guarantee product based on the allocation of assets in an investment account linked to the guarantee product. The fee factor is a metric used by the server computing device 202 to quantify a relative degree of risk associated with the allocation of assets in a particular investment vehicle (e.g., the Covered Asset Pool). It should be appreciated that other metrics and measurements of risk in an investment account or asset portfolio can be used to quantify a relative degree of risk without departing from the scope of the invention.

In one embodiment, the server computing device 202 calculates the fee factor by evaluating the allocation of assets in the Covered Asset Pool on a fund-by-fund basis. For example, the guarantor may allow an Owner to invest the assets in a wide range of different investment choices (e.g., mutual funds, equities, bonds) within the investment account. The total composition of the Covered Asset Pool, i.e., how much is invested in each investment choice, is considered the asset allocation of the Covered Asset Pool.

Each investment choice is assigned a fund factor that indicates whether the investment choice is more risky or less risky. For example, a particular investment choice (Mutual Fund #1) may be assigned a fund factor of 0.8 while another choice (Mutual Fund #2) may be assigned a fund factor of 1.5, and yet another choice (Cash Fund) may be assigned a fund factor of zero. In this example, a higher fund factor relates to a higher risk of a loss in value. In some embodiments, the fund factor can range from zero (lowest risk) to two (highest risk). In some embodiments, the fund factor is based on a level of volatility of the associated fund, a level of equity exposure of the associated fund, and/or a confidence rating of the associated fund. It should be appreciated that different scales and values for the fund factor can be used without departing from the scope of the invention.

The server computing device 202 multiplies the asset amount allocated to each investment choice by the fund factor to determine a covered asset value for each investment choice and then adds the covered asset value for each investment choice together, as shown in the exemplary calculation below.

Covered Asset Pool - Asset Allocation

| | | Fund Factor | Covered Asset |
|---|---|---|---|
| Investment Choice | Asset Amount (A) | (B) | Value (A × B) |
| Mutual Fund 1 | $100,000 | 1 | $100,000 |
| Mutual Fund 2 | $25,000 | 1.5 | $37,500 |
| Cash Fund | $50,000 | 0 | $0 |
| Total | $175,000 | | $137,500 |

The server computing device 202 compares the covered asset value for the entire Covered Asset Pool with the total asset amount in the Covered Asset Pool to determine the fee factor associated with the guarantee product. In the above example, the server computing device determines that the fee factor is 78.57%, or the covered asset value of $137,500 divided by the asset amount of $175,000. Periodically over the term of the Certificate, the server computing device 202 can adjust the fee factor based on changes to the allocation of assets in the Covered Asset Pool. Once the fee factor has been adjusted, the server computing device 202 can update the investment profile based on the adjusted fee factor.

Once the fee factor is determined, the server computing device 202 assigns (304) an investment profile to the guarantee product based on the fee factor. Generally, each investment profile is defined as a range of fee factors that correspond to the level of risk associated with a particular asset allocation. In one example, the fee factor range for each investment profile is as follows:

| Investment Profile | Fee Factor |
|---|---|
| A | >70%-80% |
| B | >60%-70% |
| C | >50%-60% |
| D | >40%-50% |
| E | >30%-40% |
| F | 0%-30% |

Continuing with the previous example, the server computing device 202 assigns Investment Profile A to the guarantee product because the fee factor for the guarantee product was determined to be 78.57%.

The server computing device 202 determines (306) a fee percentage for the guarantee product based on the investment profile and a fee payment option selected by the Certificate Owner. Each investment profile is associated with a fee percentage that is used to calculate the Certificate Fee for the guarantee product. However, the fee percentage is also based on a fee payment option selected by the Certificate Owner.

The fee payment option (or fee option) is based on the method by which the Owner elects to pay the Certificate Fee imposed on the guarantee product. Certain fee options are associated with a lower fee percentage than other fee options. For example, under one fee option (Fee Option #1), the Certificate Fee (and any Advisory Fees) are paid from a separate cash account associated with the Owner. Therefore, the Certificate Fee (and any Advisory Fees) are not deducted from the Covered Asset Pool. Because the fees do not take away any value in the Covered Asset Pool, the risk is reduced that the Covered Asset Pool may eventually be depleted. As a result, the guarantor can lower the fee percentage when Fee Option #1 is selected.

Under other fee options, the Owner is permitted to withdraw some combination of the Certificate Fee and/or Advisory Fees (up to a maximum percentage) out of the Covered Asset Pool each Certificate Year without such Withdrawals being considered Excess Withdrawals. The total applicable Certificate Fee and/or Advisory Fee that may be withdrawn each Certificate Year without such Withdrawals being considered Excess Withdrawals is referred to as the “Annual Fee Allowance.” Any Advisory Fees that exceed the maximum amount specified for the selected Fee Option may not be deducted from the Covered Asset Pool and must be paid from assets outside the Covered Asset Pool. In addition, any Withdrawal not properly identified as a Withdrawal to pay the Certificate Fee or Advisory Fee is not counted as a Withdrawal Covered by the Annual Fee Allowance and may result in an Excess Withdrawal.

The fee options may also be associated with different fee bases to calculate the Certificate Fee. For example, under one fee option, the Certificate Fee is a percentage of the Covered Asset Pool, whereas under another fee option, the Certificate Fee is a percentage of the Coverage Base. Accordingly, a choice between these fee options may depend, in part, on the extent to which the Owner expects the Covered Asset Pool to be higher or lower than the Coverage Base while he owns the Certificate due to investment performance, step ups, and/or expected Withdrawals.

In some embodiments, the Owner can change the fee option periodically over the term of the Certificate. The server computing device 202 can determine a new fee percentage and a new fee amount whenever the fee payment option is changed.

The following table shows exemplary fee options, including the fee basis and how the Certificate Fees and Advisory Fees are deducted for each option:

| | | | Maximum | |
|---|---|---|---|---|
| | | | Percentage of | |
| | Certificate | | Advisory Fee | |
| | Fee | | from Covered | |
| | from | Advisory Fee | Assets (as a % | Certificate |
| Fee | Covered | from Covered | of the Covered | Fee |
| Option | Assets? | Assets? | Asset Pool) | Fee Basis |
| Option 1 | No | No | N/A | Covered Asset |
| | | | | Pool |
| Option 2 | No | Yes | 1.00% | Coverage Base |
| Option 3 | No | Yes | 1.50% | Coverage Base |
| Option 4 | Yes | No | N/A | Coverage Base |
| Option 5 | Yes | Yes | 1.00% | Coverage Base |
| Option 6 | Yes | Yes | 1.50% | Coverage Base |

Below is an example of how the Advisory Fee Withdrawal is calculated under a particular fee option.

Advisory Fee Withdrawal Example A:
Assume the Certificate Date is Jan. 1, 2013 and Fee Option 2 is chosen (1% Advisory Fee), and Withdrawals are made as follows:

| | | Covered | | |
|---|---|---|---|---|
| | | Asset Pool | | |
| | Advisory | Value on | | Cumulative |
| Date of | Fee | date of | Percentage | Percentage |
| Withdrawal | Withdrawn | Withdrawal | Withdrawn | Withdrawn |
| Mar. 1, 2013 | $250 | $100,000 | 0.25% | 0.25% |
| Jun. 15, 2013 | $275 | $110,000 | 0.25% | 0.50% |
| Sep. 12, 2013 | $300 | $120,000 | 0.25% | 0.75% |
| Dec. 25, 2013 | $225 | $90,000 | 0.25% | 1.00% |
| Total: | | | 1.00% | |

Result:
In this Example, the cumulative Withdrawals in the Certificate Year for the Advisory Fees do not exceed the maximum percentage for the Fee Option. The Advisory Fees withdrawn would not result in an Excess Withdrawal.

Below is another example of how the Advisory Fee Withdrawal is calculated under a particular fee option.

Advisory Fee Withdrawal Example B:
Assume the Certificate Date is Jan. 1, 2013 and Fee Option 2 is chosen (1% Advisory Fee) and Withdrawals are made as follows:

| | | Covered | | |
|---|---|---|---|---|
| | | Asset Pool | | |
| | Advisory | Value on | | Cumulative |
| Date of | Fee | date of | Percentage | Percentage |
| Withdrawal | Withdrawn | Withdrawal | Withdrawn | Withdrawn |
| Mar. 1, 2013 | $315 | $100,000 | 0.25% | 0.25% |
| Jun. 15, 2013 | $205 | $110,000 | 0.20% | 0.45% |
| Sep. 12, 2013 | $310 | $120,000 | 0.30% | 0.75% |
| Dec. 25, 2013 | $250 | $90,000 | 0.30% | 1.05% |
| Total: | | | 1.05% | |

Result:
In this Example, cumulative withdrawals in the Certificate Year for Advisory Fees exceed the maximum percentage for the Fee Option. The amount of $33.73 would be considered an Excess Withdrawal.

A table with exemplary fee percentages for each investment profile and fee option is set forth below:

Certificate Fee Table

| | Fee Option 1 (% of | | Fee Option 2 (% of | | Fee Option 3 (% of | |
|---|---|---|---|---|---|---|
| Investment | Covered Asset Base) | | Coverage Base) | | Coverage Base) | |
| Profile | Current | Maximum | Current | Maximum | Current | Maximum |
| Profile A | 1.0 | 1.2 | 1.3 | 1.5 | 1.6 | 1.8 |
| Profile B | 0.9 | 1.1 | 1.2 | 1.4 | 1.5 | 1.7 |
| Profile C | 0.8 | 1.0 | 1.1 | 1.3 | 1.4 | 1.6 |
| Profile D | 0.7 | 0.9 | 1.0 | 1.2 | 1.3 | 1.5 |
| Profile E | 0.6 | 0.8 | 0.9 | 1.1 | 1.2 | 1.4 |
| Profile F | 0.5 | 0.7 | 0.8 | 1.0 | 1.1 | 1.3 |
| | Fee Option 4 | | Fee Option 5 (% of | | Fee Option 6 (% of | |
| Investment | (% of Coverage Base) | | Coverage Base) | | Coverage Base) | |
| Profile | Current | Maximum | Current | Maximum | Current | Maximum |
| Profile A | 2.5 | 2.7 | 2.8 | 3.0 | 3.1 | 3.3 |
| Profile B | 2.4 | 2.6 | 2.7 | 2.9 | 3.0 | 3.2 |
| Profile C | 2.3 | 2.5 | 2.6 | 2.8 | 2.9 | 3.1 |
| Profile D | 2.2 | 2.4 | 2.5 | 2.7 | 2.8 | 3.0 |
| Profile E | 2.1 | 2.3 | 2.4 | 2.6 | 2.7 | 2.9 |
| Profile F | 2.0 | 2.2 | 2.3 | 2.5 | 2.6 | 2.8 |

Once the server computing device 202 determines the fee percentage that is applicable to the guarantee product, the server computing device 202 generates (308) a notification including a fee amount for the guarantee product—where the fee amount is based on the fee percentage. Using the above examples, assuming the Covered Asset Pool equals $150,000, if the server computing device 202 assigned Investment Profile F to the guarantee product and the Owner selected Fee Option 1, the server computing device 202 determines the fee amount by multiplying the applicable fee percentage (2.25%) by the Covered Asset Base ($150,000), or a fee amount of $750.

The server computing device 202 can transmit the notification including the fee amount to the owner in any number of ways, including but not limited to, postal mail, e-mail, messaging, phone call, and the like. In some embodiments, the notification is delivered to the user electronically in real-time (e.g., using browser software on a client device). In some embodiments, the server computing device 202 can automatically deduct the fee amount in accordance with the fee option selected.

### Composition Requirements for Covered Asset Pool

As mentioned previously, the guarantor can impose composition requirements on the Covered Asset Pool. For example, the Covered Asset Pool may not exceed a particular level of risk or cannot be allocated to certain funds over a specific percentage. Typically, the Owner is responsible for monitoring and rebalancing the investment account in order to maintain compliance with the composition requirements. In some cases, the Certificate may terminate and no benefits are paid if the assets in the investment account do not comply with the composition requirements.

In some embodiments, the assets in the investment account (i) must be allocated exclusively to Eligible Assets, and (ii) must be invested in accordance with specified investment parameters (i.e., composition requirement percentages). In some embodiments, the Eligible Assets consist of Eligible Funds and Eligible Strategies. Eligible Funds include mutual funds, including exchange traded funds or “ETFs” approved and monitored by the guarantor. Eligible Strategies are designated groups of mutual funds and ETFs held in accordance with allocation percentages and requirements. Individual investments (mutual funds and ETFs) held in accordance with an Eligible Strategy are referred to as Eligible Strategy Funds.

Generally, the Owner must choose to invest either (i) in Eligible Funds, or (ii) in Eligible Strategy Funds according to an Eligible Strategy. If the Owner selects an Eligible Strategy, the Owner must allocate 100% of the Covered Asset Pool to the Eligible Strategy Funds designated for the Eligible Strategy.

Some or all of the Eligible Funds may also be Eligible Strategy Funds. If the Owner selects an Eligible Strategy, the Certificate is subject to the Certificate Fee and composition requirements applicable to the Eligible Strategy selected, even if the investments also correspond to Eligible Funds. Similarly, if the Owner chooses to invest in Eligible Funds, the Certificate is subject to the Certificate Fee and composition requirements applicable to Eligible Fund investments, even if the investments also correspond to Eligible Strategy Funds designated for an Eligible Strategy. However, subject to the terms of the Certificate, the Owner may transfer from an Eligible Strategy to Eligible Funds, or from Eligible Funds to an Eligible Strategy pursuant to a Covered Asset Transfer.

### Eligible Fund Composition Requirements

This section provides exemplary composition requirements that may be used in accordance with the present invention. In order to comply with the composition requirements applicable to Eligible Funds (i) the percentage of the Covered Asset Value invested in any asset class category may not exceed the specified maximum percentage for the category (“Asset Category Cap”), and (ii) the fee factor (used for calculating the Certificate Fee) must not exceed the maximum fee factor percentage (“Fee Factor Cap”) (e.g., 80%). Exemplary Asset Category Caps for the asset class categories are as follows:

| Asset Class | | |
|---|---|---|
| Category | Asset Class Description | Asset Category Cap |
| 1 | International Investment Grade Debt | 50% |
| 2 | Core Investment Grade Debt | 100% |
| 3 | High Yield Debt | 20% |
| 4 | International High Yield Debt | 10% |
| 5 | Emerging Markets Debt | 10% |
| 6 | Real Estate | 10% |
| 7 | International Large Equity | 50% |
| 8 | Domestic Large Equity | 80% |
| 9 | Commodities | 10% |
| 10 | Domestic Mid Cap Equity | 25% |
| 11 | Domestic Small Cap Equity | 15% |
| 12 | Emerging Markets Small Equity | 5% |
| 13 | Hedge Funds | 5% |
| 14 | International Small Equity | 10% |
| 15 | Emerging Markets Large Equity | 10% |
| 16 | Balanced | 100% |

The guarantor may reassign one or more Eligible Funds to different asset class categories or change the associated fund factors. Below is an example of how compliance with the Asset Category Caps is determined:

| Covered Fund | Covered Asset Value | Asset Class Category |
|---|---|---|
| Mutual Fund 1 | $50,000 | 8 |
| Mutual Fund 2 | $60,000 | 2 |
| Mutual Fund 3 | $10,000 | 11 |
| Mutual Fund 4 | $12,000 | 11 |
| Total | $132,000 | |

| | Sum of | | | |
|---|---|---|---|---|
| Asset Class | Covered Asset | Percentage | Asset Category | Pass or |
| Category | Values for Category | of Total | Cap | Fail |
| 2 | $60,000 | 45% | 100% | Pass |
| 8 | $50,000 | 38% | 80% | Pass |
| 11 | $22,000 | 17% | 15% | Fail |

In the above example, the Covered Asset Values do not comply with the Asset Category Caps.

Below is another example of how compliance with the Asset Category Caps is determined:

| Covered Funds | Covered Asset Value | Asset Class Category |
|---|---|---|
| Mutual Fund 1 | $50,000 | 8 |
| Mutual Fund 2 | $60,000 | 2 |
| Mutual Fund 3 | $10,000 | 11 |
| Mutual Fund 4 | $8,000 | 11 |
| Total | $128,000 | |

| | Sum of | | | |
|---|---|---|---|---|
| Asset Class | Covered Asset | Percentage | Asset Category | Pass or |
| Category | Values for Category | of Total | Cap | Fail |
| 2 | $60,000 | 47% | 100% | Pass |
| 8 | $50,000 | 39% | 80% | Pass |
| 11 | $18,000 | 14% | 15% | Pass |

In the above example, the Covered Asset Values do comply with the Asset Category Caps.

Periodically, the computing device 202 determines whether the allocation of assets in the Covered Asset Pool account is still in compliance with the composition requirements assigned to the guarantee product. External effects such as market fluctuation, or internal effects such as contribution of additional assets to the Covered Asset Pool or reallocation of the assets by the investor, can affect both the overall asset allocation in the Pool as well as the particular asset allocation for each of the asset categories within the Pool. In some cases, these effects may cause the allocation of assets to shift out of compliance with the assigned risk profile for the guarantee product.

In some embodiments, the computing device 202 conducts a determination of compliance according to a predetermined schedule (e.g., monthly, quarterly) based on the calendar year. In some embodiments, the computing device 202 conducts a determination of compliance according to a predetermined schedule (e.g., monthly, quarterly) based on the Certificate Year. For example, at the end of a predetermined period, the computing device 202 analyzes the asset allocation in the Covered Asset Pool account and determines whether the asset allocation meets the composition requirements. If there have been changes to the asset allocation that places the Covered Asset Pool out of compliance with the risk profile, the computing device 202 can take one or more actions as described in greater detail below. The computing device 202 conducts the determination at the end of each schedule period.

Whenever the computing device 202 determines that the Covered Asset Pool account is no longer in compliance with the composition requirements, the computing device 202 can perform a number of different actions, either individually or in combination with each other. FIG. 4 is a flow diagram of a method 400 for performing an action or series of actions whenever the Covered Asset Pool is no longer in compliance with the composition requirements, using the system 200 of FIG. 2.

The computing device 202 determines (402) that the Covered Asset Pool is not in compliance with the composition requirements. In some embodiments, the computing device 202 transmits (404) a notice to the Certificate Owner indicating that the Covered Asset Pool is no longer in compliance with the composition requirements. The notice can establish a predetermined time period in which the Certificate Owner must cure the defect in the Covered Asset Pool account to bring the Pool back into compliance with the composition requirements.

The computing device 202 can initiate transmission of the notice via any number of communication methods: e-mail, text message, instant message, letter, telephone call, and/or fax. The computing device 202 can perform the transmission of the notice automatically, or interact with other systems to complete the transmission. For example, the computing device 202 can be coupled to an Interactive Voice Response (IVR) system that automatically calls out to the Certificate Owner with the notice. In another example, the computing device 202 can flag the Certificate Owner's policy and/or profile for a customer service representative to view and perform a procedure to contact the Certificate Owner.

In some embodiments, the computing device 202 automatically rebalances (406) or reallocates the assets in the Covered Asset Pool account to achieve compliance with the composition requirements whenever the computing device 202 determines (402) that the Covered Asset Pool is no longer in compliance with the composition requirements. For example, the computing device 202 can issue a rebalancing request to the financial institution that manages the Covered Asset Pool.

In some embodiments, the computing device 202 assesses (408) a penalty against the Certificate Owner based on noncompliance of the Covered Asset Pool with the composition requirements. The penalty can include any or all of: charging a fee to the Covered Asset Pool account, forced reallocation of assets in the Covered Asset Pool to achieve compliance with the composition requirements, adjustment of the guarantee associated with the guarantee product, and termination of the guarantee product. In some embodiments, the computing device 202 does not assess the penalty unless the asset allocation in the Covered Asset Pool is still not in compliance with the composition requirements after a certain time period (i.e., a cure period).

The techniques may be implemented in a networked system 500 comprising multiple computing devices distributed across different locations, as shown in FIG. 5. Each of Location A 510a, Location B 510b and Location C 510c includes the server computing device 202 having components 204, 206, 208 of FIG. 2, and the servers at locations 510a, 510b, and 510c are connected to each other via the network 504. The networked system of FIG. 5 enables distribution of the processing functions described herein across several computing devices and provides redundancy in the event that a computing device at one location is offline or inoperable. In some embodiments, client computing devices (e.g., device 502) in proximity to a particular location (e.g., Location A 510a) access the networked system via the server 202 at that location. In some embodiments, the server computing devices 202 at the respective locations 510a-510c communicate with a central computing device 512 (e.g., a server) that is coupled to the network. The central computing device 512 can provide data and/or processing resources for the network of server computing devices 202 (e.g., synchronization of functionality/data across the computing devices).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, a 3GPP Long Term Evolution (LTE) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, tablet device, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device includes, for example, a Blackberry®, an iPhone®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method for dynamic pricing of guarantee products, the method comprising:
determining, by a server computing device, a fee factor for a guarantee product based on an allocation of assets in an investment account linked to the guarantee product, the fee factor representing a level of risk associated with the allocation of assets;
assigning, by the server computing device, an investment profile to the guarantee product based on the fee factor;
determining, by the server computing device, a fee percentage for the guarantee product based on the investment profile and a fee payment option selected by an owner of the guarantee product; and
generating, by the server computing device, a notification including a fee amount for the guarantee product based on the fee percentage.

2. The method of claim 1, wherein the step of determining a fee factor comprises:
determining a covered asset value for each investment choice in the investment account in which assets are allocated, the covered asset value being a value of assets in the fund multiplied by a fund factor; and
determining the fee factor by dividing the total covered asset value for every investment choice in the investment account by the total value of assets in the investment account.

3. The method of claim 2, wherein the fund factor is based a level of volatility of the associated fund.

4. The method of claim 2, wherein the fund factor is based on a level of equity exposure of the associated fund.

5. The method of claim 2, wherein the fund factor is based on a confidence rating of the associated fund.

6. The method of claim 1, wherein the fee payment option provides that the fee amount is deducted from a separate cash account associated with the guarantee product.

7. The method of claim 1, wherein the fee payment option provides that the fee amount is deducted from the investment account associated with the guarantee product.

8. The method of claim 1, further comprising:
periodically adjusting, by the server computing device, the fee factor based on changes to the allocation of assets in the investment account; and
updating, by the server computing device, the investment profile based on the adjusted fee factor.

9. The method of claim 1, further comprising:
periodically determining, by the server computing device, whether the allocation of assets in the investment account satisfies a compliance threshold; and
generating, by the server computing device, a notification for the owner of the guarantee product whenever the allocation of assets does not satisfy the compliance threshold.

10. The method of claim 9, further comprising:
rebalancing, by the server computing device, the allocation of assets in the investment account whenever the allocation of assets does not satisfy the compliance threshold.

11. The method of claim 1, further comprising:
determining, by the server computing device, a new fee percentage and fee amount whenever the fee payment option is changed.

12. A system for dynamic pricing of guarantee products, the system comprising a server computing device with a processor configured to:
determine a fee factor for a guarantee product based on an allocation of assets in an investment account linked to the guarantee product, the fee factor representing a level of risk associated with the allocation of assets;
assign an investment profile to the guarantee product based on the fee factor;
determine a fee percentage for the guarantee product based on the investment profile and a fee payment option selected by an owner of the guarantee product; and
generate a notification including a fee amount for the guarantee product based on the fee percentage.

13. The system of claim 12, wherein the step of determining a fee factor comprises:
determining a covered asset value for each fund in the investment account in which assets are allocated, the covered asset value being a value of assets in the fund multiplied by a fund factor; and
determining the fee factor by dividing the total covered asset value for every fund in the investment account by the total value of assets in the investment account.

14. The system of claim 13, wherein the fund factor is based a level of volatility of the associated fund.

15. The system of claim 13, wherein the fund factor is based on a level of equity exposure of the associated fund.

16. The system of claim 13, wherein the fund factor is based on a confidence rating of the associated fund.

17. The system of claim 12, wherein the fee payment option provides that the fee amount is deducted from a separate cash account associated with the guarantee product.

18. The system of claim 12, wherein the fee payment option provides that the fee amount is deducted from the investment account associated with the guarantee product.

19. The system of claim 12, the processor further configured to:
periodically adjust the fee factor based on changes to the allocation of assets in the investment account; and
update the investment profile based on the adjusted fee factor.

20. The system of claim 12, the processor further configured to:
periodically determine whether the allocation of assets in the investment account satisfies a compliance threshold; and
generate a notification for the owner of the guarantee product whenever the allocation of assets exceeds the compliance threshold.

21. The system of claim 20, the processor further configured to:
rebalance the allocation of assets in the investment account whenever the allocation of assets exceeds the compliance threshold.

22. The system of claim 12, the processor further configured to:
determine a new fee percentage and fee amount whenever the fee payment option is changed.

23. A computer program product, tangibly embodied in a non-transitory computer readable storage medium, for dynamic pricing of guarantee products, the computer program product including instructions operable to cause a data processing apparatus to:
determine a fee factor for a guarantee product based on an allocation of assets in an investment account linked to the guarantee product, the fee factor representing a level of risk associated with the allocation of assets;
assign an investment profile to the guarantee product based on the fee factor;
determine a fee percentage for the guarantee product based on the investment profile and a fee payment option selected by an owner of the guarantee product; and
generate a notification including a fee amount for the guarantee product based on the fee percentage.
